(19) United States
(12) Patent Application Publication
(10) Pub. No.: US 2026/0341546 A1
(43) Pub. Date: Oct. 29, 2026

(54) Coated Nuclear Fuel Particle Fabrication by Solution Coating and Laser-Induced Chemical Conversion

(71) Applicant: University of Utah Research Foundation, Salt Lake City, UT (US)

(72) Inventors: Ashutosh TIWARI, Salt Lake City, UT (US); Gitanjali MISHRA, Salt Lake City, UT (US); Carson MINOR, Salt Lake City, UT (US)

(21) Appl. No.: 19/229,161

(22) Filed: Jun. 5, 2025

Related U.S. Application Data
(60) Provisional application No. 63/656,534, filed on Jun. 5, 2024.

(51) Int. Cl. G21C 21/02; C09D 1/00; C09D 5/32; C09D 7/20; G21C 3/04

(52) U.S. Cl. CPC G21C 21/02; C09D 1/00; C09D 5/32; C09D 7/20; G21C 3/045

(57) ABSTRACT

A method of making a coated nuclear fuel particle can include providing a solid fuel kernel and forming one or more layers on the solid fuel kernel using a solution coating and laser-induced chemical conversion process. The process can include applying a coating of a solution that includes a dissolved carbon source or silicon source to form a source film. The source film can then be exposed to a controlled pulsed laser beam sufficient to convert the source film to carbon, silicon carbide, or a combination thereof.

### CROSS REFERENCE TO RELATED APPLICATIONS

This application claims priority to U.S. Provisional Patent Application No. 63/656,534, filed on Jun. 5, 2024, which is hereby incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

Not applicable.

### BACKGROUND

Tri-structural isotropic (TRISO) nuclear fuel particles are a type of coated nuclear fuel particle that can include a fuel kernel encapsulated by coating layers such as carbon and ceramic coatings. The coatings on each particle act as a containment system which can retain fission products in the fuel kernel. TRISO fuel particles can be resistant to mechanical stress, corrosion, and high temperatures. This type of nuclear fuel can be highly resistant to melting, even at high temperatures such as 1800 °C or higher.

A typical TRISO nuclear fuel particle is currently made using chemical vapor deposition (CVD) processes for each layer. This method, while established, faces limitations in terms of scalability, and economy. Challenges with CVD include its potential for variability in coating thickness and uniformity. Such thickness inconsistency can adversely affect the overall performance and safety of the nuclear fuel, posing a challenge in meeting the stringent requirements of advanced nuclear reactors. TRISO fuel particles can be particularly useful for microreactors.

Generation IV nuclear reactors represent a significant advancement in nuclear technology, emphasizing sustainability, safety, and efficiency. These reactors can utilize pebble fuel, which consists of spherical fuel elements with thousands of micro-fuel particles encapsulated in protective layers. The individual micro-fuel particles can be TRISO particles in some cases. However, current methods of fabricating these particles, such as CVD, face challenges in scalability, precision, and uniformity.

### SUMMARY

Recognizing these challenges, the methods described herein can provide a way to make coated nuclear fuel particles with improved scalability, precision, and uniformity, which can improve the overall performance of the fuel particles.

In one example, a method of making a coated nuclear fuel particle can include providing a solid fuel kernel and forming one or more layers on the solid fuel kernel using a solution coating and laser-induced chemical conversion process. This process can include applying a coating of a solution comprising a dissolved carbon source or silicon source to form a source film, and exposing the source film to a controlled pulsed laser beam sufficient to convert the source film to carbon, silicon carbide, or a combination thereof. In certain examples, the methods described herein can be used to make TRISO nuclear fuel particles or quadruple isotropic (QUADRISO) nuclear fuel particles. Coated fuel particles made using these methods can also be used in pebble fuel, which includes a plurality of the coated nuclear fuel particles embedded in a matrix.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIGS. 1A-1I illustrate cross-sectional views of steps in an example method of making a coated nuclear fuel particle in accordance with an example of the present technology.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “a layer” includes reference to one or more of such features and reference to “coating” refers to one or more of such steps.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” and “at least one of A, B or C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Methods of Making Coated Nuclear Fuel Particles

Nuclear fuel particles can include a fuel kernel that comprises fissile material such as uranium, and one or more coating layers deposited on the fuel kernel. The methods described herein provide a new approach for forming coating layers on a fuel kernel. The coatings can be formed by applying a solution of a source material, such as a carbon source or a silicon source. The source material can be a carbon or silicon compound that is soluble in a solvent to form the solution. The solution coating can be at least partially dried to form a source film, and then the source film can be exposed to a controlled pulsed laser beam. The energy provided by the laser beam can chemically convert the source film to a layer of a carbon, silicon, carbide, or a combination of these.

In certain examples, the methods described herein can include the “LaserTRISO” process, which refers to the use of the solution coating/laser-induced chemical conversion process utilized to make TRISO nuclear fuel particles. Multiple protective layers can be formed on micro-sized oxide fuel particles. This method significantly deviates from the traditional chemical vapor deposition techniques, enhancing precision, efficiency, and control in the production process.

The solution-based deposition of carbon and silicon source materials can be followed by pulsed laser decomposition to form each of the layers in a TRISO nuclear fuel particle. In certain examples, an excimer pulsed laser can be used and specific pulse durations and intensities can be varied. The laser beam can decompose the carbon or silicon source material to form a layer of solid carbon or silicon carbide. The use of a pulsed excimer laser is particularly useful since it can be precisely controlled in terms of pulse duration (e.g. ~25 nanoseconds) and intensity which allows for very precise control of uniformity in each layer thickness and integrity.

In one example, the process can begin with commercially procured micron-sized oxide fuel particles, which form the core for the TRISO fuel. These particles can undergo a series of sophisticated coating steps. First, a porous carbon layer can be applied. In a particular example, a solution of sucrose dissolved in water can be prepared as the carbon source, and the solution can be aged to ensure uniformity. The oxide fuel particles can be dipped in this sucrose solution, forming a thin film upon drying. These coated particles can be exposed to a controlled laser beam, which induces the carbonization of the sucrose resulting in a porous carbon layer.

A layer of pyrolytic carbon can be formed over the porous carbon layer. This layer can be referred to as an “inner pyrolytic carbon layer.” To form this layer, the sucrose solution's concentration can be adjusted to produce a denser carbon layer. A layer of this modified solution can be applied to the particles, followed by laser exposure, creating the inner pyrolytic carbon layer.

A silicon carbide (SiC) layer can then be formed over the inner pyrolytic carbon layer. For the SiC layer, silicon acetate can be dissolved in ethanol and mixed with the aged sucrose solution. This mixture, once aged, can be applied over the previously coated particles. Laser treatment of these coated particles can facilitate a reaction between silicon from the silicon acetate and carbon from sucrose, forming a SiC layer.

Another layer of pyrolytic carbon can be formed over the silicon carbide layer. This layer can be referred to as the “outer pyrolytic carbon layer.” This layer can be formed by applying another layer of the modified sucrose solution, followed by a laser treatment to create a dense, impermeable outer pyrolytic carbon layer. Each stage of this process can be precisely controlled, with real-time monitoring ensuring the uniformity and integrity of each layer. This state-of-the-art approach to fabricating TRISO fuel particles has the potential to transform the landscape of nuclear fuel production, perfectly aligning with the needs of advanced reactor designs and contributing to a safer, more efficient nuclear energy generation.

This approach can increase the application precision of protective layers on TRISO fuel particles compared to traditional CVD methods. The laser-induced process can ensure meticulously controlled layer thickness and uniformity, which can increase the safety and efficiency of the nuclear fuel. The technology can also streamline the TRISO fuel manufacturing process, reducing time and complexity. The processes described herein can have better scalability than conventional methods, and can allow for large-scale production without compromising quality, thereby reducing costs and accelerating TRISO fuel availability for advanced reactors. The LaserTRISO process can incorporate real-time monitoring, revolutionizing quality assurance in nuclear fuel production. This can enable immediate adjustments for any layer thickness or composition deviations, ensuring each fuel particle meets the highest quality standards for reactor safety.

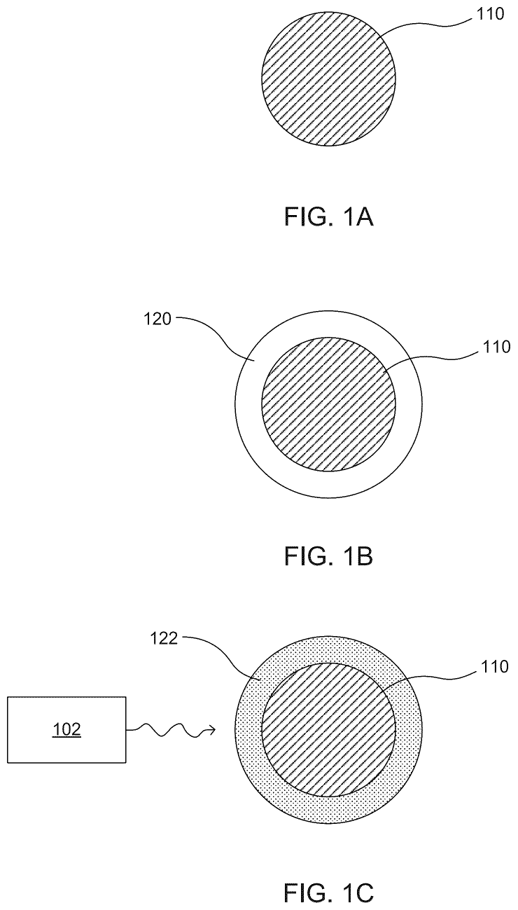

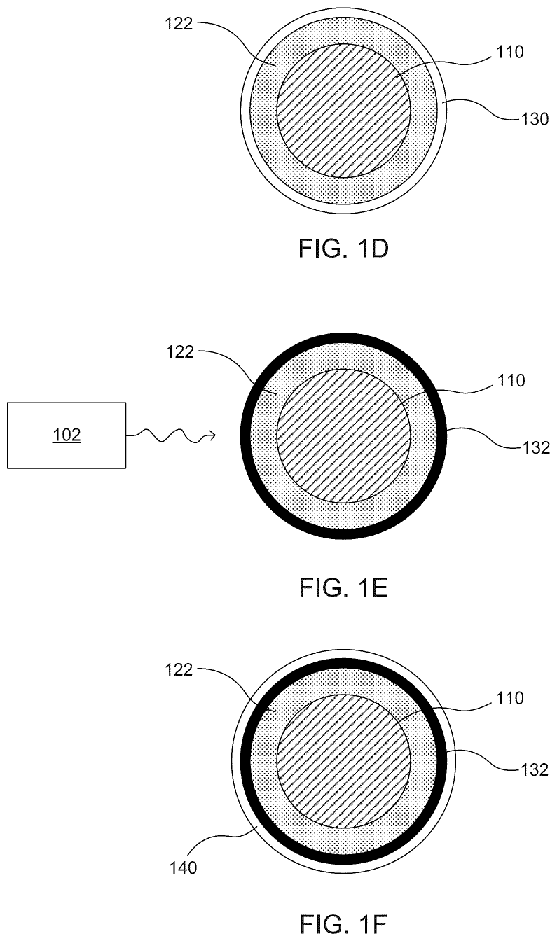

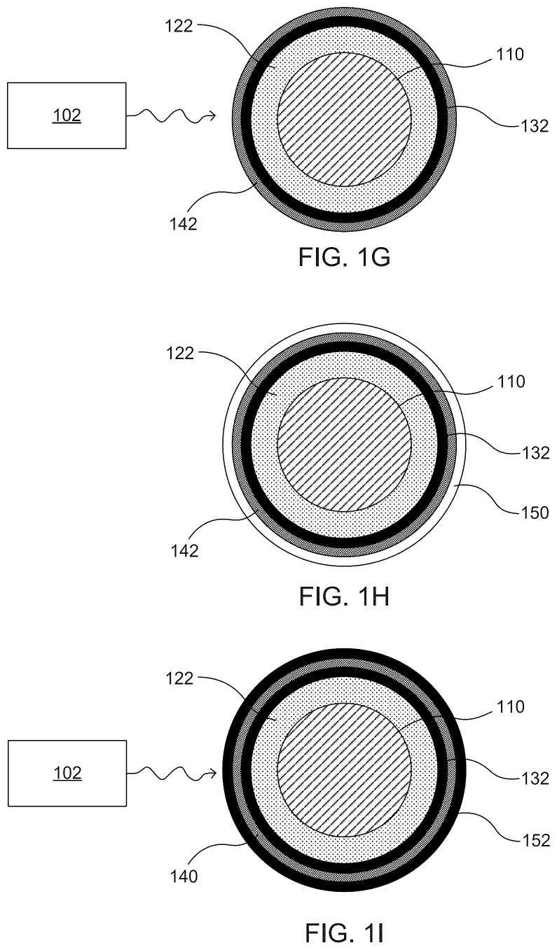

One example method of making a coated nuclear fuel particle is illustrated by FIGS. 1A-1I. FIG. 1A shows a fuel kernel 110. In FIG. 1B, a coating of a first carbon source solution is applied on the solid fuel kernel to form a first carbon source film 120. The first carbon source film can have a substantially uniform thickness over the surface area of the fuel kernel in some examples. This figure shows a schematic cross-sectional view of the particle. FIG. 1C shows a laser 102 emitting a laser beam that is sufficient to convert the first carbon source film to a porous carbon layer 122. In FIG. 1D, another layer of a second carbon source solution is applied to form a second carbon source film 130. In some examples, the second carbon source solution can be prepared with a different concentration of the carbon source than in the first carbon source solution. The second carbon source solution can be capable of forming a denser carbon layer when dried and converted by a laser beam to a carbon layer. FIG. 1E shows the laser 102 being used to convert the second carbon source film to an inner pyrolytic carbon layer 132. After forming the inner pyrolytic carbon layer, a silicon carbide source solution can be applied over the inner pyrolytic carbon layer to form a silicon carbide precursor film 140 as shown in FIG. 1F. The silicon carbide source solution can include a dissolved silicon source and a dissolved carbon source, so that the silicon source and the carbon source can react to form silicon carbide when energized by the laser. FIG. 1G shows the laser emitting a laser beam onto the silicon carbide precursor film, sufficient to convert the silicon carbide precursor film into a silicon carbide layer 142. A coating of a third carbon source solution is then applied over the silicon carbide layer to form a third carbon source film 150 as shown in FIG. 1H. In some examples, the third carbon source film can have substantially the same composition as the second carbon source film. FIG. 1I shows the laser 102 being used to convert the third carbon source film to an outer pyrolytic carbon layer 152.

A variety of materials can be suitable for use in the fuel kernel and in the one or more coatings on the fuel kernel. The fuel kernel can include a fissile material that is suitable for use as a nuclear fuel. The fuel kernel can also include other elements in addition to fissile elements. In certain examples, the fuel kernel can include ZrO₂, CeO₂, Sm₂O₃, ThO₂, UCO, UO₂, PuO₂, MOX, minor actinide oxides (e.g. oxides of Np, Am, Cm, Bk, and Cf), or a combination thereof. In some particular examples, the fuel kernel can include UCO. The stoichiometry of uranium, carbon, and oxygen atoms in UCO can vary, and may not necessarily by 1:1:1. In some examples, UCO can have a formula such as UCₓO₂₋ₓ, UC₁₋ₓOₓ, UO₂, UC₂, or combinations of multiple phases having these formulae. In further examples, non-fissile additives can also be included in the fuel kernel, such as oxygen getters, neutron poisons, structural materials, or others. Non-limiting examples of oxygen getters can include zirconium, titanium, cerium, oxides thereof, and the like. Non-limiting examples of neutron poisons can include gadolinium oxide (Gd₂O₃), samarium oxide (Sm₂O₃), boron carbide (B₄C), and the like. Non-limiting examples of structural materials can include silicon carbide (SiC), molybdenum, and the like.

In some examples, the fuel kernel can be made using a sol-gel process. In the case of uranium oxide fuel kernels, a uranyl gel can be annealed to obtain uranium oxide microparticles. Other suitable processes can also be used to form microparticles of fuel materials that can be used as the fuel kernel. The fuel kernel can be a small particle with a diameter from about 200 μm to about 2,000 μm in some examples. In further examples, the fuel kernel can have a diameter from about 200 μm to about 1,000 μm, or from about 200 μm to about 800 μm, or from about 200 μm to about 600 μm, or from about 200 μm to about 400 μm, or from about 400 μm to about 1,000 μm. When a nuclear fuel comprising many particles is prepared, the average diameter of fuel kernels in the nuclear fuel can be within any of these ranges.

The one or more layers that are formed on the fuel kernel can individually have a layer thickness from about 20 μm to about 200 μm in some examples. In further examples, the individual layers can have a layer thickness from about 20 μm to about 100 μm, or from about 100 μm to about 200 μm. When multiple layers are formed on the fuel kernel, the collective thickness of the layers can be from about 40 μm to about 500 μm in some examples, or from about 40 μm to about 400 μm, or from about 100 μm to about 400 μm, or from about 200 μm to about 400 μm. In certain examples, one or more of the layers can have a substantially equal thickness to each other. In other examples, one or more of the layers can have a greater thickness compared to other layers.

In various examples, the layers formed on the fuel kernel can include one or more porous carbon layers, one or more pyrolytic carbon layers, one or more silicon carbide layers, or combinations of these. In certain examples, a porous carbon layer is formed on the solid fuel kernel, followed by forming an inner pyrolytic carbon layer on the porous carbon layer. A silicon carbide layer is then formed on the inner pyrolytic carbon layer, and an outer pyrolytic carbon layer is formed on the silicon carbide layer.

The porous carbon layer can be formed by applying a coating of a first carbon source solution on the solid fuel kernel. The first carbon source can include a solvent and a carbon source comprising a carbon-containing compound that is soluble in the solvent. In some examples, the solvent can comprise water, ethanol, acetone, benzene, or other solvents. The carbon source can comprise a sugar, a starch, an acetate, or other organic compounds. In certain examples, the carbon source can be a sugar and the solvent can be water. The first carbon source solution can include the carbon source at a concentration from about 5 wt % to about 30 wt %, in some examples, and in some cases from 10 wt % to 20 wt %.

Some specific example carbon source materials that can be used include sugars, starches, acetates, and other organic compounds. Some specific sugars that can be used include sucrose, glucose, fructose, galactose, lactose, maltose, and combinations of these. Starches that can be used can include starches modified to be water soluble. Some example starches can include potato starch, corn starch, cassava starch, dextrin, arrowroot, hydroxypropyl starch, and others.

A variety of coating processes can be used to coat the fuel kernel with the first carbon source solution. In some examples, the coating can be formed by dip coating, spray coating, curtain coating, 3D printing, fluidized bed coating, spray coating in a rotary drum, spraying the solid particles together with the first carbon source solution, spin coating, doctor blading, electrospraying, electrostatic spray deposition, roll coating, or another suitable coating process. After coating the fuel kernel with the liquid carbon source solution, the source solution can be at least partially dried to form a film of the carbon source. In some examples, the drying can be a separate step after coating, or the drying can occur at the same time as the coating. Drying can be performed by waiting for a sufficient drying time with or without the application of heat or flowing dry air or other gas to facilitate drying. The coating and drying processes can be controlled to help control the thickness of the source film. For example, the temperature of the source solution, the temperature of the fuel kernel, and the drying temperature can affect the thickness of the source film. Additionally, the solution concentration, coating time, and drying time can also affect the thickness of the source film. Therefore, in some examples these parameters can be varied to control the source film thickness.

It can also be useful to age the carbon source solution after dissolving the carbon source in the solvent, before applying the solution to the fuel kernel. Aging the solution can be accomplished simply by waiting for an appropriate time after dissolving the carbon source in the solvent. This can ensure that the carbon source compound has sufficient time to fully dissolve and that the dissolved carbon source can diffuse throughout the solution to make the solution homogeneous. Aging the solution in this way can help increase the uniformity of the source film formed from the solution. In some examples, the solution can be aged for a time from about 1 minute to about 24 hours, or from about 1 minute to about 1 hour, or from about 1 minute to about 10 minutes, or from about 1 hour to about 24 hours, or from about 6 hours to about 24 hours. Aging can be performed at room temperature, or at a warmer temperature such as from about 20 °C to about 80 °C in some examples.

These coating and drying processes can be used for forming source films for any of the various layers described herein, such as the porous carbon layer, the inner pyrolytic carbon layer, the silicon carbide layer, and the outer pyrolytic carbon layer.

When the first carbon source film has been formed, the film can then be converted into a porous carbon layer using a controlled pulsed laser beam. The laser beam can apply sufficient energy to the source film to convert the source film to porous carbon through a carbonization process. In some examples, the laser beam can be produced by an excimer laser, an arc laser, a microwave laser, or a combination thereof. Excimer lasers, which can also include exciplex lasers, can be ultraviolet lasers that produce light through an excited dimer or complex. Some such laser can include a combination of a noble gas and a halogen gas. Under appropriate conditions of electrical stimulation and high pressure, a pseudo-molecule called an excimer or exciplex can be formed. The excited pseudo-molecule can release its excess energy, emitting ultraviolet light. Some example types of excimer laser (and their wavelengths) that can be used include argon (126 nm), krypton (146 nm), fluorine (157 nm), xenon (172-175 nm), ArF (193 nm), KrCl (222 nm), KrF (248 nm), XeBr (282 nm), XeCl (308 nm), XeF (351 nm), and combinations thereof. In further examples, a laser having an emission wavelength from about 120 nm to about 360 nm can be used.

The laser bean can be pulsed at a suitable pulse rate and pulse duration to convert the carbon source film into the porous carbon layer. In some examples, the pulse rate of the laser beam can be from about 5 Hz to about 10,000 Hz, or from about 100 Hz to about 1,000 Hz, or from about 1,000 Hz to about 10,000 Hz. The pulse duration can be from about 1 ns to about 10 μs, or from about 10 ns to about 10 μs, or from about 10 ns to about 1 μs, or from about 10 ns to about 100 ns, or from about 10 ns to about 50 ns, in some examples. In certain examples, the pulse duration can be about 25 ns.

The pulse rate, pulse duration, number of pulses applied to the particle, and other parameters of the laser beam can be adjusted to control properties of the layer being formed. In some examples, one or more properties of the layer can be monitored and the parameters of the laser beam can be adjusted to adjust the one or more properties of the layer. In certain examples, the one or more properties of the layer can be monitored in real time and the parameters of the laser beam can be adjusted in real time while the source film is being converted in to a carbon layer. The property of the layer that is monitored can include the layer composition, thickness, adherence, or a combination thereof. These properties can be monitored using any suitable technique. For example, real-time reflectometry can be used which tracks the reflectance of the surface as a function of laser exposure. Changes in reflectance correlate with a degree of carbonization and an evolving layer thickness. Based on these signals, the laser parameters, e.g. pulse energy, pulse count, and scan speed, can be adjusted dynamically to achieve a more uniform thickness and consistent composition. For example, if reflectance indicates a slower conversion rate in a particular area, one or both of the laser pulse count and energy can be increased slightly to achieve the target thickness. In addition, SEM and Raman spectroscopy can be used post-process to validate uniformity and composition.

In some examples, a controller can be in electronic communication with the laser and with one or more sensors that are configured to monitor the one or more properties of the layer. The controller can be programmed to automatically measure a property of the layer using the sensor and to automatically adjust a parameter of the laser in response to the measurement. In certain examples, the controller can be programmed to determine when the process of converting the carbon source layer to a porous carbon layer has been completed, at which point the controller can automatically stop the application of the pulsed laser beam. In further examples, the laser can be moveable or the particle can be moveable (i.e., on a motorized moveable stage) so that the laser beam can be directed at different locations on a particle. The controller can also be in electronic communication with the movement motors to direct the laser beam. The controller can be programmed to automatically direct the laser beam to areas of the source layer that are to be carbonized. In further examples, the controller can be programmed to measure a thickness of the layer. The controller can be further programmed to use the laser to remove material from areas that are above a certain threshold thickness. Thus, the controller can use the laser to form a coating of uniform thickness.

The controller can be operable to perform the functions described above through the use of one or more processors and one or more modules that may be included in the controller. The modules can include a movement control module operable to control movement of the laser beam, the particles being treated, or both. The modules can also include a laser control module operable to adjust the laser intensity, pulse rate, pulse duration, and other parameters of the laser. Other modules can also be included such as a memory module, a communications module, a sensor module, a user interface module, and others.

In certain examples, the thickness of the porous carbon layer can be from about 20 μm to about 200 μm, or from about 40 μm to about 200 μm, or from about 80 μm to about 200 μm, or from about 80 μm to about 160 μm.

The fuel particles can be exposed to the laser beam individually or in a group. In some examples, the laser beam can be directed at a single fuel particle to carbonize the source film on the particle and form a porous carbon layer. If there are a plurality of fuel particles being made, the laser can be directed to each individual particle one at a time in certain examples. Alternatively, the laser beam can be directed at multiple particles simultaneously in some examples. In still further examples, the laser beam can be directed to various portions of multiple different particles in any order, and the laser beam may return to a given particle multiple times to convert different portions of the source film on each particle to the porous carbon layer. In some cases, the laser beam can be directed at the fuel particles while the fuel particles are held in a vessel, or the particles can be placed in one or more layers on a stage, or in a channel, or on a vibrating stage, or in a fluidized bed, or in a rotary drum, or in another location.

After forming the porous carbon layer, a similar solution coating and laser-induced chemical conversion process can be used to form the inner pyrolytic carbon layer over the porous carbon layer. The inner pyrolytic carbon layer can be formed by applying a coating of a second carbon source solution on the porous carbon layer. This coating can be made using any of the coating processes described above. The coating can also be dried using any of the drying processes described above. This can form a second carbon source film on the fuel particle. A controlled pulsed laser beam can then be applied to carbonize the second carbon source film, thereby converting the second carbon source film into the inner pyrolytic carbon layer. This laser-induced chemical conversion process can include any of the features and characteristics described above.

The inner pyrolytic carbon layer can have a higher density than the porous carbon layer. In some examples, the increased density can be achieved by using a different concentration of carbon source material in the second carbon source solution compared to the first carbon source solution. For example, the second carbon source solution can have a higher concentration than the first carbon source solution. In other examples, the second carbon source solution can have a lower concentration than the first carbon source solution. The second carbon source solution can have a concentration from 10 wt % to 40 wt % in some examples, and in some cases from 20 wt % to 30 wt %. Notably, a higher concentration relative to the first carbon source allows for increased density in the inner pyrolytic carbon layer. In still further examples, the second carbon source solution can include a different carbon source material than the first carbon source solution. However, in some examples, the second carbon source solution can include the same carbon source material as the first carbon source solution, but the solution can be modified by changing the concentration of the carbon source material.

In certain examples, the inner pyrolytic carbon layer can have a layer thickness that is less than the layer thickness of the porous carbon layer. In certain examples, the inner pyrolytic carbon layer can have a thickness from about 20 μm to about 200 μm, or from about 20 μm to about 100 μm, or from about 20 μm to about 80 μm, or from about 20 μm to about 60 μm.

A silicon carbide layer can be formed over the inner pyrolytic carbon layer. The silicon carbide layer can be formed by applying a coating of a silicon carbide source solution to form a silicon carbide precursor film. The silicon carbide source solution can include both a silicon source material and a carbon source material dissolved in a solvent. In some examples, different solvents can be used to dissolve the silicon source material and the carbon source material, and then the resulting solutions can be mixed to make the silicon carbide source solution. Some example silicon source materials that can be used include silicon acetate, silicon oxalate, silicon propionate, silicon butyrate, tetraethyl orthosilicate, tetrapropyl orthosilicate, tetrabutyl orthosilicate, organosilicon compounds, silicon ethoxide, silicon methoxide, polysiloxanes (e.g., PDMS), silanes (e.g., methyltriethoxysilane, phenyltriethoxysilane), organosilanes, silicon alkoxides, and combinations thereof. In some cases, these can be soluble in different solvents than the carbon source materials. Some example solvents that can be used to dissolve silicon source materials include ethanol, acetone, benzene, and other organic solvents. In certain examples, the silicon source material can be dissolved in a first solvent and the carbon source material can be dissolved in a second solvent that is miscible with the first solvent. In a particular example, the silicon source material can be dissolved in ethanol and the carbon source material can be a sugar dissolved in water. The solution of the silicon source material in ethanol can then be mixed with the solution of sugar in water to make the silicon carbide source solution. As with the carbon source solutions described above, in some examples the silicon carbide source solution can be aged before applying the silicon carbide source solution to the fuel particle.

In some examples, the silicon carbide source solution can include a carbon source at a concentration from 5 wt % to 25 wt %, and in some cases 10 wt % to 20 wt %, while a molar ratio of silicon atoms to carbon atoms in the silicon carbide precursor film can be 1:5 to 5:1, and in some cases 1:2 to 2:1. In further examples, a molar ratio of silicon atoms to carbon atoms in the silicon carbide precursor film can be from 1:5 to 5:1, or from 1:3 to 3:1, or form 1:2 to 2:1. The ratio can be achieved by varying the amounts of silicon source and carbon source that are added in the silicon carbide precursor solution.

The silicon carbide source solution can be applied using any of the coating processes described above. The coating can also be dried using any of the drying processes described above to form a silicon carbide precursor film. The film can then be converted to silicon carbide by a controlled pulsed laser beam. The laser-induced chemical conversion process described above can be used. The laser beam can provide sufficient energy to cause the silicon source material to react with the carbon source material, forming silicon carbide. The laser beam can have a pulse rate and pulse duration in any of the ranges described. After the silicon carbide precursor film has been converted to a silicon carbide layer, the layer can have a ratio of silicon atoms to carbon atoms from 1:2 to 2:1 in some examples.

The silicon carbide layer can have a layer thickness similar to the porous carbon layer and the inner pyrolytic carbon layer. In certain examples, the silicon carbide layer can be thicker than the inner pyrolytic carbon layer and thinner than the porous carbon layer. The silicon carbide layer can have a layer thickness from about 20 μm to about 200 μm, or from about 30 μm to about 150 μm, or from about 30 μm to about 100 μm, or from about 30 μm to about 80 μm in some examples. The silicon carbide layer can be sufficient strong to act as a pressure vessel to contain pressurized material, such as fission products that may form in the fuel kernel. In some examples, the silicon carbide layer can be capable of containing pressures from 20 MPA to 200 MPa, or from 50 MPa to 150 MPa, or from 100 MPa to 150 MPa.

An outer pyrolytic carbon layer can be formed over the silicon carbide layer. This layer can be formed by applying a coating of a third carbon source solution to form a third carbon source film. The third carbon source solution can be applied using any of the coating processes described above. The third carbon source solution can also be dried using any of the drying processes described above. The outer pyrolytic carbon layer can have a density similar to the inner pyrolytic carbon layer and therefore the third carbon source solution can have a composition capable of forming a dense carbon layer. In certain examples, the third carbon source solution can have the same composition as the second carbon source solution. In other examples, the third carbon source solution can be different from the second carbon source solution, but can include any of the ingredients and amounts described above for the first or second carbon source solutions.

A laser-induced chemical conversion process can be used to convert the third carbon source film into the outer pyrolytic carbon layer. This process can include any of the features and characteristics described above. In certain examples, the same laser can be used for forming all the layers of the fuel particle. The final outer pyrolytic carbon layer can have a similar thickness to the inner pyrolytic carbon layer. In certain examples, the outer pyrolytic carbon layer can have a thickness from about 20 μm to about 200 μm, or from about 20 μm to about 100 μm, or from about 20 μm to about 80 μm, or from about 20 μm to about 60 μm.

The coated particles made using the methods described herein can provide increased fission product containment, mechanical integrity, and thermal stability. The coating layers can indefinitely contain high pressure gases that can be formed during fission, preventing the release of dangerous radioactive material. The coating layers can also have high mechanical strength which can further reduce risk of releasing radioactive material even when damage may occur to the fuel due to shock or accident. The materials used in the coatings are stable at very high temperatures, and will not melt at the temperatures encountered in nuclear reactors. This can reduce or eliminate the risk of meltdown. The coated fuel particles made using the methods described herein can also have increased coating uniformity compared to coated fuel particles made by previous methods, making the fuel particles even more reliable.

After forming the layers, the coated particles can optionally undergo annealing in an inert atmosphere (e.g. argon) at temperatures between 1000 °C and 1200 °C. This step can help relieve residual stresses, improve microstructural stability, and ensure adhesion between layers. For storage, the coated fuel particles are typically kept in a dry, inert environment (such as an argon-filled glovebox) to prevent moisture uptake or oxidation. As a general guideline, no additional coatings or surface treatments need to be applied at this stage, as the existing layers provide sufficient mechanical integrity, thermal stability, and fission product containment for intended reactor use.

The particular example fuel particles that include a fuel kernel, porous carbon layer, inner pyrolytic carbon layer, silicon carbide layer, and outer pyrolytic carbon layer can be used as TRISO fuel particles. These particles can be utilized in any nuclear energy system or process that is designed to be powered by TRISO fuel particles. The solution coating and laser-induced chemical conversion techniques described herein can also be used to make other fuel particles that may have more layers, fewer layers, different layers, and so on.

In further examples, the methods described herein can be used to make QUADRISO fuel particles. In certain examples, these particles can include a fuel kernel made up of a fissile material and a layer of a burnable absorber (also referred to as a poison). The burnable absorber can flatten the reactivity profile of the fuel during operation of a reactor by absorbing neutrons. In particular, the absorber can absorb neutrons more strongly at first, when the reactivity of the fissile material is highest. The absorber can be degraded over time (i.e., “burning”) which reduces the absorption of neutrons, but the reactivity of the fissile material can also be reduced over time. This can make the reactivity more consistent over time. Similar layers, such as a porous carbon layer, inner pyrolytic carbon layer, silicon carbide layer, and outer pyrolytic carbon layer, can be formed on the fuel kernel to make a QUADRISO particle.

Consistent with these principles, additional optional coatings and layers can be incorporated into the fuel particles. Non-limiting examples of such layers can include barrier layers, graded composition layers, functional coatings, and the like. Barrier layers can be used for fission product retention. More specifically, adding a metallic diffusion barrier layer (e.g., molybdenum, zirconium, or a refractory metal carbide/nitride layer) between SiC and outer carbon can enhance fission product retention and corrosion resistance. Graded composition layers can be formed having a graded composition (e.g., C-rich to SiC-rich gradient) instead of sharp interfaces which can reduce thermal stress and improve mechanical integrity. Functional coatings can be formed as a coating doped with neutron poisons (e.g., gadolinium or samarium compounds) that can also provide burnable absorption properties.

Coated fuel particles made using the methods described herein can also be used to make pebble fuel, which can include many of the coated fuel particles bound together and embedded in a matrix. In some examples, the matrix can include graphite, silicon carbide, resin, or combinations thereof. For example, a mixture of 80-90% graphite and 10-20% resin can be used to bind hundreds or thousands of individual TRISO fuel particles together. Pebble fuel can be in the form of spheres with a diameter of a few centimeters in certain examples (e.g. 4 cm to 10 cm and in some cases about 6 cm) although other shapes can be used. Some pebble fuels can include a core made up of fuel particles embedded in the matrix, with a surrounding outer layer of the matrix material without any fuel particles.

As an example, pebble fuel manufacturing can involve embedding a large number of coated fuel particles (such as TRISO particles) by mixing in a matrix material, e.g. 80-90% graphite and 10-20% resin (such as phenolic resin). The mixture is homogenized, then molded into spherical shapes with diameters typically ranging from 4 cm to 10 cm (with ~6 cm being most common). Other shapes, such as cylindrical or toroidal forms, can also be fabricated depending on reactor design requirements. The pebbles can be formed by pressing the mixture into the desired shape, followed by a curing process at moderate temperatures (e.g., ~180 °C) and optional post-curing at higher temperatures to achieve mechanical strength and thermal stability. Pebble fuels may also include a core of fuel particles surrounded by an outer matrix layer that contains no fuel particles, providing additional structural support and containment.

### EXAMPLES

TRISO fuel particles were produced using a method as described herein. Fuel kernels were commercially procured micron-sized oxide fuel particles, which form the core for the TRISO fuel. A series of sophisticated coating steps were performed using the LaserTRISO technology.

A porous carbon layer was first formed on the fuel kernel. Initially, a solution of sucrose dissolved in water was prepared as the carbon source, which was then aged to ensure uniformity. The oxide fuel particles were dipped in this sucrose solution, forming a thin film upon drying. These coated particles were exposed to a controlled excimer laser beam, inducing the carbonization of the sucrose and resulting in a porous carbon layer.

An inner pyrolytic carbon layer was formed next. The sucrose solution's concentration was adjusted to produce a denser carbon layer. A second layer of this modified solution was applied to the particles, followed by laser exposure, creating the inner pyrolytic carbon layer.

Next, a silicon carbide layer was formed over the inner pyrolytic carbon layer. Silicon acetate was dissolved in ethanol and mixed with the aged sucrose solution. This mixture was aged and then applied over the previously coated particles. Laser treatment of these coated particles facilitated a reaction between silicon from the silicon acetate and carbon from sucrose, forming a SiC layer.

An outer pyrolytic carbon layer was then formed over the SiC layer. The particles were coated with the modified sucrose solution again, followed by a laser treatment to create a dense, impermeable outer pyrolytic carbon layer.

The steps described in this example were repeated with fuel kernels made of ZrO₂, CeO₂, and Sm₂O₃. More specifically, for the laser treatment used to convert the carbon source films into pyrolytic carbon layers, an excimer laser (KrF, 248 nm) with a pulse duration of ~25 ns and a pulse rate of 100-1000 Hz was used. The laser fluence (energy density) was maintained in the range of 0.1-1 J/cm², depending on the layer being processed. To ensure uniformity across the surface of the particles, a motorized stage was used to move the particles relative to the laser beam, using a raster scanning pattern with controlled overlap between passes to ensure complete and consistent laser coverage. During processing, real-time reflectometry was used to monitor the layer formation by observing changes in reflectance, which correlates with carbonization and thickness evolution. Based on these signals, laser parameters of pulse count, scan speed, and spot overlap were adjusted dynamically to achieve uniform layer thickness and desired density. These process controls allowed achievement of dense, impermeable outer pyrolytic carbon layers with consistent properties across batches.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method of making a coated nuclear fuel particle, comprising:
providing a solid fuel kernel; and
forming one or more layers on the solid fuel kernel using a solution coating and laser-induced chemical conversion process comprising:
applying a coating of a solution comprising a dissolved carbon source or silicon source to form a source film, and
exposing the source film to a controlled pulsed laser beam sufficient to convert the source film to carbon, silicon carbide, or a combination thereof.

2. The method of claim 1, wherein the one or more layers comprise a porous carbon layer, a pyrolytic carbon layer, a silicon carbide layer, or a combination thereof.

3. The method of claim 2, wherein forming the one or more layers comprises forming a porous carbon layer on the solid fuel kernel, forming an inner pyrolytic carbon layer on the porous carbon layer, forming a silicon carbide layer on the inner pyrolytic carbon layer, and forming an outer pyrolytic carbon layer on the silicon carbide layer.

4. The method of claim 3, wherein forming the porous carbon layer comprises applying a coating of a first carbon source solution on the solid fuel kernel to form a first carbon source film, and exposing the first carbon source film to a controlled pulsed laser beam sufficient to convert the first carbon source film to the porous carbon layer;
wherein forming the inner pyrolytic carbon layer comprises applying a coating of a second carbon source solution on the porous carbon layer to form a second carbon source film, and exposing the second carbon source film to the controlled pulsed laser beam sufficient to convert the second carbon source film to the inner pyrolytic carbon layer;
wherein forming the silicon carbide layer comprises applying a coating of a silicon carbide source solution on the inner pyrolytic carbon layer to form a silicon carbide precursor film, wherein the silicon carbide source solution comprises a dissolved silicon source and a dissolved carbon source, and exposing the silicon carbide precursor film to the controlled pulsed laser beam sufficient to convert the silicon carbide precursor film to the silicon carbide layer; and
wherein forming the outer pyrolytic carbon layer comprises applying a coating of a third carbon source solution on the silicon carbide layer to form a third carbon source film, and exposing the third carbon source film to a controlled pulsed laser beam sufficient to convert the third carbon source film to the outer pyrolytic carbon layer.

5. The method of claim 4, wherein the second carbon source solution has a concentration that is higher than the first carbon source solution.

6. The method of claim 4, wherein the first carbon source solution has a concentration from 5 wt % to 30 wt %, and wherein the second carbon source solution has a concentration from 10 wt % to 40 wt %, wherein the silicon carbide source solution comprises the silicon source at a concentration from 5 wt % to 25 wt %, and wherein the third carbon source solution has a concentration from 10 wt % to 40 wt %.

7. The method of claim 1, wherein the carbon source comprises a sugar.

8. The method of claim 7, wherein the sugar comprises sucrose, glucose, fructose, galactose, lactose, maltose, or a combination thereof.

9. The method of claim 1, wherein the silicon source comprises silicon acetate, silicon oxalate, silicon propionate, silicon butyrate, tetraethyl orthosilicate, tetrapropyl orthosilicate, tetrabutyl orthosilicate, an organosilicon compound, silicon ethoxide, silicon methoxide, polysiloxanes, silanes, organosilanes, silicon alkoxides, and combinations thereof.

10. The method of claim 1, wherein the solution comprises water, ethanol, an organic solvent, or a combination thereof.

11. The method of claim 1, wherein the one or more layers have an individual layer thickness from about 20 μm to about 200 μm.

12. The method of claim 1, wherein the fuel kernel has a diameter from about 200 μm to about 2,000 μm.

13. The method of claim 1, wherein the fuel kernel comprises ZrO₂, CeO₂, Sm₂O₃, ThO₂, UCO, UO₂, PuO₂, minor actinide oxides, or a combination thereof.

14. The method of claim 1, wherein the coating of the solution is applied by spraying, 3D printing, dipping, curtain coating, fluidized bed coating, spin coating, doctor blading, electrospraying, electrostatic spray deposition, roll coating, spray coating in a rotary drum, or a combination thereof.

15. The method of claim 1, wherein forming the source film comprises drying the coating of the solution.

16. The method of claim 1, further comprising controlling a thickness of the source film by varying one or more of temperature, solution concentration, coating time, and drying time.

17. The method of claim 1, further comprising aging the solution for a time period of at least one hour before applying the coating.

18. The method of claim 1, wherein the laser beam is produced by an arc laser, a microwave laser, an excimer laser, or a combination thereof.

19. The method of claim 1, wherein the laser beam has a wavelength from about 120 nm to about 360 nm, is pulsed at a pulse duration from about 1 ns to about 10 μs, and is pulsed at a pulse rate from about 5 Hz to about 10,000 Hz.

20. The method of claim 1, further comprising monitoring the layers and adjusting a parameter of the laser beam in real time to adjust a property of the layers.

21. The method of claim 1, further comprising depositing one or more of a barrier layer, graded composition layer, and a functional coating with neutron poisons.

22. The method of claim 1, wherein the coated nuclear fuel particle is a tri-isotropic (TRISO) nuclear fuel particle or a quadruple isotropic (QUADRISO) nuclear fuel particle.

23. The method of claim 22, wherein the nuclear fuel particle is the QUADRISO nuclear fuel particle and wherein the fuel kernel comprises a layer of a burnable absorber.

24. A pebble fuel comprising a plurality of coated nuclear fuel particles made using the method of claim 1 embedded in a matrix.

25. The pebble fuel of claim 24, wherein the matrix comprises graphite, silicon carbide, resin, or a combination thereof.
